(19) United States
(12) Patent Application Publication
(10) Pub. No.: US 2005/0274217 A1
(43) Pub. Date: Dec. 15, 2005

(54) Transmission gear selector switch on shift lever

(76) Inventors: Kurt D. Dubay, Merrill, MI (US); Henry A. Eurich, Saginaw, MI (US); Reggie S. Rezmer, Frankenmuth, MI (US); Thomas M. Glowacki, Freeland, MI (US); Frederick J. Berg, Auburn, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/855,814

(22) Filed: May 27, 2004

(51) Int. Cl. G05G 9/00

(52) U.S. Cl. 74/473.12

(57) ABSTRACT

The invention provides an apparatus having a steering column for supporting a steering wheel, a first gear selector for controlling a selection of a gear arrangement of a transmission from among a first set of a plurality of different gear arrangements, and a second gear selector for controlling a selection of a gear arrangement of a transmission from among a second set of the plurality of different gear arrangements. The first and second sets of gear arrangements are different from one another. The first gear selector is mounted for movement about the steering column. The first and second gear selectors operate in parallel with respect to one another to set the gear arrangement of a transmission of a vehicle.

### FIELD OF THE INVENTION

The invention relates to an apparatus for switching gears in an automatic transmission and more particularly to a lever mountable with respect to a steering column.

### BACKGROUND OF THE INVENTION

A vehicle transmission includes a plurality of gears that are movable relative to one another to define different gear arrangements such as park, neutral, reverse, drive, low one and low two. Transmissions can also be operated in other gear arrangements such a “tow/haul” and/or “traction control.” The driver of the vehicle engages a lever mounted on a steering column to manipulate the transmission and change the gear arrangement. The lever moves about the steering column along a path of movement and is locked in detent positions defined by the steering column at various positions along the path of movement. The length of the path of movement corresponds with the number of gear arrangements.

### SUMMARY OF THE INVENTION AND ADVANTAGES

The invention provides an apparatus having a steering column for supporting a steering wheel, a first gear selector for controlling a selection of a gear arrangement of a transmission from among a first set of a plurality of different gear arrangements, and a second gear selector for controlling a selection of a gear arrangement of a transmission from among a second set of the plurality of different gear arrangements. The first and second sets of gear arrangements are different from one another. The first gear selector is mounted for movement about the steering column. The second gear selector can be mounted on the first gear selector. The first and second gear selectors operate in parallel with respect to one another to set the gear arrangement of a transmission of a vehicle.

The invention enhances the control of a vehicle transmission without increasing a clearance space required for moving a gear selector such as a lever. For example, according to one embodiment, the invention can include a lever moveable along a relatively short arcuate path around the column and a switch mounted on the lever to allow a driver to choose from a plurality of different gear arrangements such as park, drive, reverse, neutral, low one, and low two. The lever is operated to select one of the park, drive, reverse, neutral, and low one gear arrangements and the switch is operated to select one of the low one and low two gear arrangements. A device according to the prior art, on the other hand, requires a lever to move along a relatively long path in order to provide the driver with the same number of gear arrangements options.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic perspective view of a first exemplary embodiment of the invention;

FIG. 2 is perspective view of a lever according to the first exemplary embodiment;

FIG. 3 is perspective view of a lever according to a second exemplary embodiment of the invention;

FIG. 4 is perspective view of a lever according to a third exemplary embodiment of the invention; and

FIG. 5 is a simplified flow diagram illustrating the process steps performed by a controller according to the exemplary embodiments of the invention.

### DETAILED DESCRIPTION OF THE PREFERRED EMBODIMENT

A plurality of different embodiments of the invention are shown in the figures of the application. Similar features are shown in the various embodiments of the invention. Similar features have been numbered with a common two-digit reference numeral and have been differentiated by a third digit placed before the common two digits. Similar features of the exemplary embodiments of the invnetion are structured similarly, operate similarly, and/or have the same function unless stated otherwise.

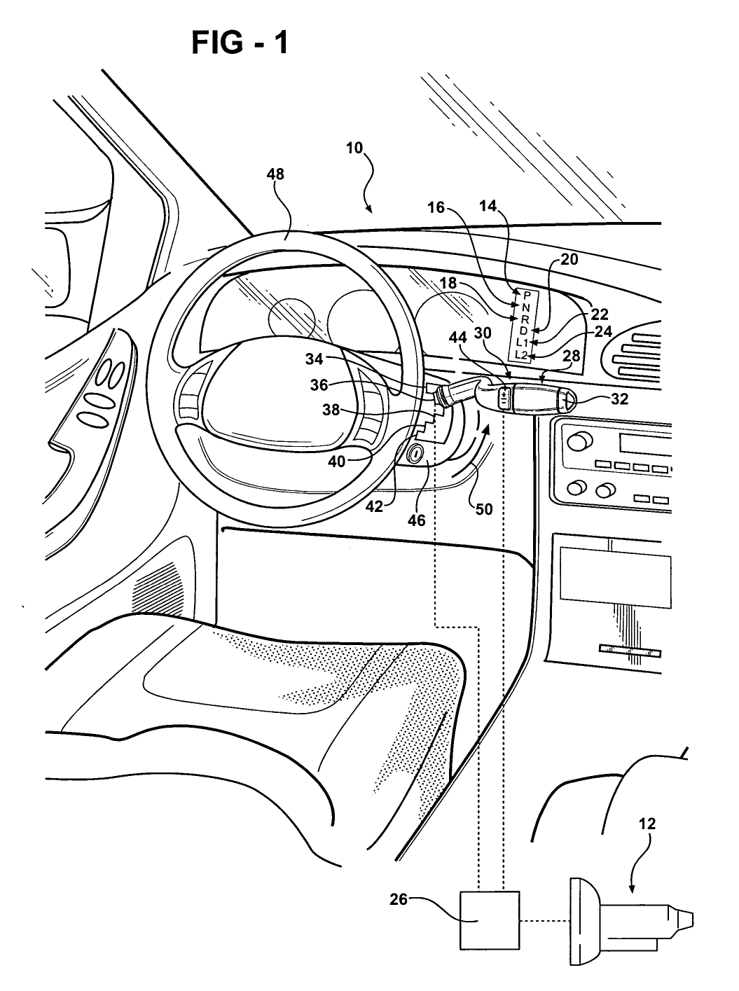

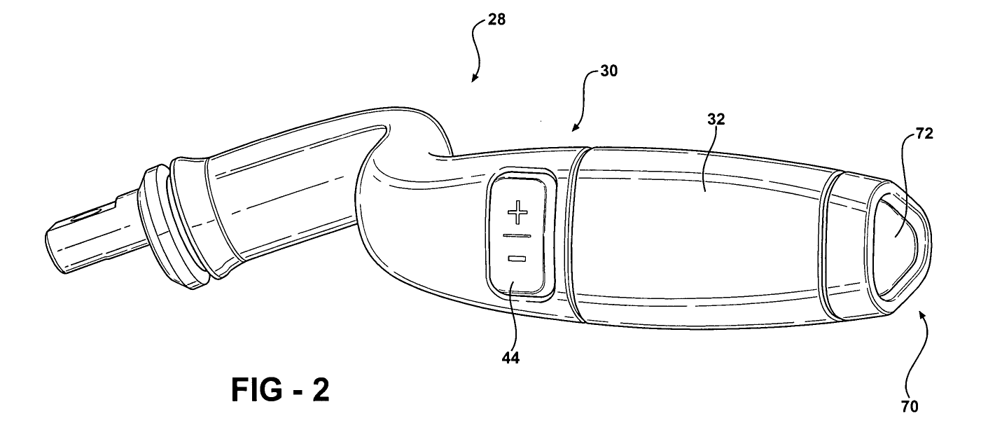

Referring now to FIGS. 1 and 2, in a first exemplary embodiment of the invention, an apparatus 10 includes a steering column 46 for supporting a steering wheel 48. The apparatus 10 also includes a first gear selector 28 for controlling a selection of a gear arrangement of a transmission 12 from among a first set of a plurality of different gear arrangements 14-24. The first gear selector 28 is mounted for movement about the steering column 46.

The transmission 12 includes a plurality of gears that are moveable with respect to one another to define a plurality of different gear arrangements 14-24. The gear arrangements include a park arrangement 14, a neutral arrangement 16, a reverse arrangement 18, a drive arrangement 20, a first low arrangement 22, and a second low arrangement 24. In alternative embodiments of the invention, the gears of the transmission 12 can define additional gear arrangements such as a tow/hall arrangement and a traction control arrangement, for example.

The apparatus 10 also includes a second gear selector 30 for controlling a selection of a gear arrangement of the transmission 12 from among a second set of the plurality of different gear arrangements 14-24. The first and second sets of gear arrangements 14-24 are different with respect to one another. The first set of gear arrangements controlled by the first gear selector 28 includes the park arrangement 14, the neutral arrangement 16, the reverse arrangement 18, and the drive arrangement 20. The second set of gear arrangements includes the first low arrangement 22 and the second low arrangement 24. The first set also includes the first low arrangement 22. In other words, a driver of the vehicle can adjust the transmission 12 to move gears into the first low arrangement 22 with either the first gear selector 28 or the second gear selector 30.

The first gear selector 28 includes a lever 32 moveable between a plurality of positions 34, 36, 38, 40, 42. Each of the plurality of positions 36-42 correspond to at least one of the plurality of different gear arrangements 14-24. For example, the position 42 corresponds to the low one gear arrangement 22. Similarly, the position 34 corresponds to the park gear arrangement 14, the position 36 corresponds to the neutral gear arrangement 16, the position 38 corresponds to the reverse gear arrangement 18, and the position 40 corresponds to the drive gear arrangement 20. The positions 34-42 are disposed along an arcuate path 50 which extends about the steering column 46. The lever 32 is moveable along the arcuate path 50 and the positions 34-42 correspond to detents in the steering column 46. The second gear selector includes a switch 44 disposed on the lever 32.

The apparatus 10 includes an electric controller 26 communicating with the first and second gear selectors 28, 30 for controlling the transmission 12. The electric controller 26 is operable to change a current gear arrangement in response to movement of the lever 32 from a first position 34-42 to a second position 34-42, and is also operable to change the current gear arrangement in response to a signal received from the switch 44. The controller 26 is operable to disregard communications from at least one of the first and second gear selectors 28, 30 in response to communications received from the other of the first and second gear selectors 28, 30.

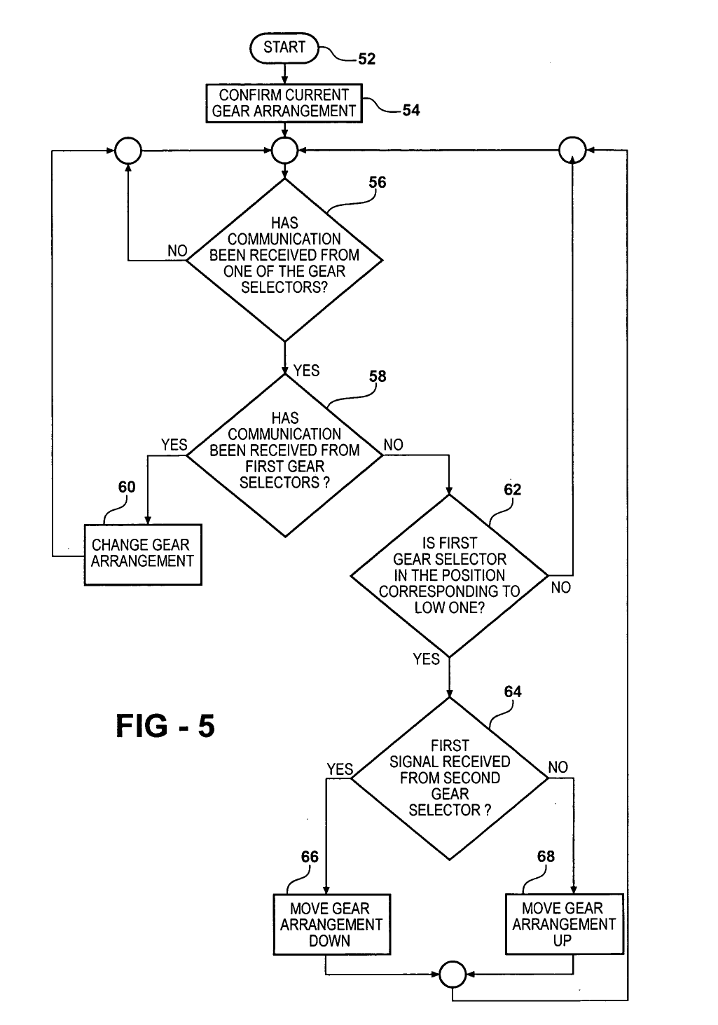

The operation of the controller 26 in controlling the transmission 12 and communicating with the first and second gear selectors 28, 30 is illustrated in the simplified flow diagram of FIG. 5. The process starts at step 52. At step 54, the controller 26 confirms the current gear arrangement. The controller 26 can communicate with sensors associated with the transmission 12 to sense the current gear arrangement and emit a signal corresponding to the current gear arrangement.

The process continues to step 56 and the controller 26 waits for receipt of a signal from one of the first and second gear selectors 28, 30. A signal from the first gear selector 28 is generated when the lever 32 is moved between two of the positions 34-42 disposed along the arcuate path 50. The controller 26 also receives a signal when the switch 44 is engaged by a driver of the vehicle. Switch 44 can be a push button sensor moveable in two directions, such as upward and downward directions, for emitting first and second signals. The first signal is generated when the switch 44 is engaged in a downward direction and the second signal generated when the switch 44 is engaged in an upward direction. If a signal has not been received, the process returns to step 56 to wait for a signal. If a signal is received, the process continues to step 58.

At step 58, the controller 26 determines whether the signal was received from the first signal generator 28. If the signal was received from the first signal generator 28, the process continues to step 60 and the desired change in the gear arrangement is completed. For example, if the signal received by the controller 26 at step 58 corresponds to a change in the position of the lever 32 from the position 42 to the position 34, the transmission is moved from low one gear arrangement 22 to the park gear arrangement 14. After step 60, the process returns to step 56.

If the signal received at step 56 is not generated by the first signal generator 28, the process moves from step 58 to step 62 and the controller 26 confirms that the first signal generator 28 is in position 42 corresponding to the low one gear arrangement 22. In the first exemplary embodiment of the invention, the controller 26 will disregard a signal received from the second signal generator 30 unless the lever 32 is disposed at the position 42. This operation enhances the safety of the invention by preventing the transmission from being shifted to a lower gear arrangement such as low two gear arrangement 24 from, for example, the reverse gear arrangement 18 or the drive gear arrangement 20. The process returns to step 56 after step 62 if the lever 32 is not disposed at the position 42. If the first signal generator 28 is disposed at the position 42 corresponding to the low one gear arrangement 22, the process continues to step 64.

At step 64, the controller 26 determines whether the signal received from the second signal generator 30 is the first signal corresponding to a downward desired gear change or the second signal corresponding to an upward desired gear change. For example, if the driver engages the switch 44 in an upward direction, the controller 26 will control the transmission 12 to move from the low two gear arrangement 24 to the low one gear arrangement 22. If the transmission 12 is already in the low one gear arrangement 22, the controller 26 will disregard the signal from the second gear selector 30. Similarly, if the driver of the vehicle engages the switch 44 in a downward direction, the controller 26 will control the transmission 12 to move from the low one gear arrangement 22 to the low two gear arrangement 24. As set forth above, in alternative embodiments of the invention, the controller 26 could control the transmission 12 to move to additional gear arrangements in addition to the low one gear arrangement 22 and the low two gear arrangement 24.

In prior art methods of adjusting the gear arrangement of the transmission 12, an arcuate path corresponding to the arcuate path 50 would be longer than the arcuate path 50 in order to provide the driver of the vehicle with a similar number of selections with respect to the gear arrangement.

If the signal received at step 64 is a first signal corresponding to downward movement of the switch 44, the process continues to step 66 and the gear arrangement is moved downward, such as from the low one gear arrangement 22 to the low two gear arrangement 24. If the signal received at step 64 is not the first signal, corresponding to upward movement of the switch 44, the process continues to step 68 and the gear arrangement is moved upward, such as from the low two gear arrangement 24 to the low one gear arrangement 22. After step 66 and/or step 68, the process returns to step 56.

The apparatus 10 can also include a third gear selector 70. The third gear selector 70 can communicate with the controller 26 to allow the driver to exercise additional control over the transmission 12. For example, the third gear selector 70 can correspond to a tow haul gear arrangement or a traction control gear arrangement. The third gear selector 70 can cooperate with either one of the first and second gear selectors 28, 30 to enhance the operation of the vehicle. For example, the driver can move the lever 32 to the position 40, corresponding to the drive gear arrangement 20, and also engage the third gear selector 70 to place the transmission 12 in traction control. The third gear selector 70 can include a push button 72.

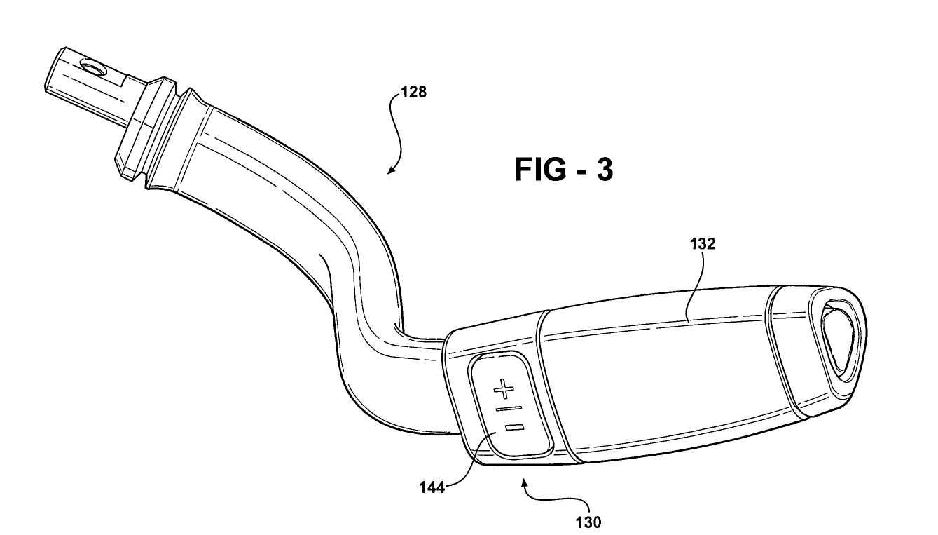

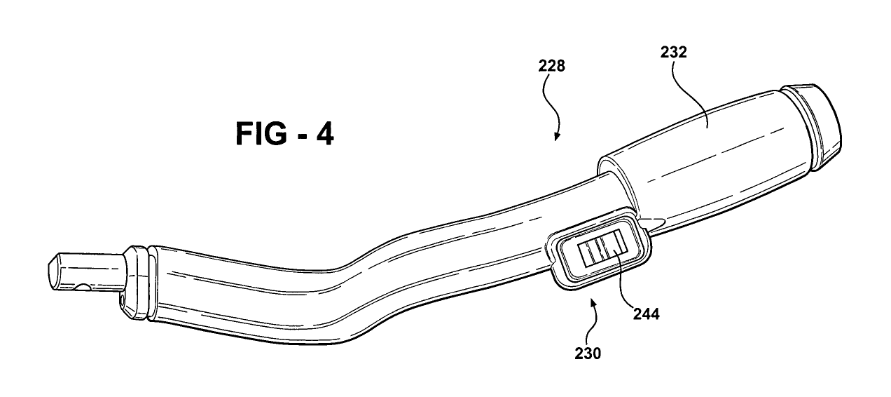

FIGS. 3 and 4 show alternative embodiments of first and second gear selectors 128, 228, 130, 230 including levers 132, 232 and switches 144, 244 respectively. The first and second gear selectors 128, 228, 130, 230 can replace the first and second gear selectors 28, 30 of the first exemplary embodiment of the invention shown in FIGS. 1 and 2.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. An apparatus comprising:
a steering column for supporting a steering wheel;
a first gear selector for controlling a selection of a gear arrangement of a transmission from among a first set of a plurality of different gear arrangements and mounted for movement about said steering column; and
a second gear selector for controlling a selection of a gear arrangement of the transmission from among a second set of the plurality of different gear arrangements, wherein said first and second sets of gear arrangements are different.

2. The apparatus of claim 1 wherein said first gear selector includes a lever moveable between a plurality of positions wherein each of said plurality of positions corresponds to at least one of said plurality of different gear arrangements.

3. The apparatus of claim 2 wherein said plurality of positions are disposed along an arcuate path.

4. The apparatus of claim 3 wherein the second gear selector includes a switch disposed on said lever.

5. The apparatus of claim 2 further comprising:
an electric controller communicating with said first and second gear selectors for controlling a transmission of a vehicle to move between the plurality of different gear arrangements.

6. The apparatus of claim 5 wherein said electric controller is operable to change a current gear arrangement in response to movement of said lever from a first position to a second position.

7. The apparatus of claim 6 wherein said electric controller is operable to disregard communications from at least one of said first and second gear selectors in response to communications received from the other of said first and second gear selectors.

8. The apparatus of claim 5 wherein said electric controller is further defined as being operable to change the current gear arrangement in response to a communication from said second gear selectors only when said lever is in one of said plurality of positions.

9. The apparatus of claim 1 wherein said first set of gear arrangements includes a park arrangement, a neutral arrangement, a reverse arrangement, and a drive arrangement.

10. The apparatus of claim 9 wherein said second set of gear arrangements includes a first low arrangement and a second low arrangement.

11. The apparatus of claim 10 wherein said first set of gear arrangements includes said first low arrangement.

12. The apparatus of claim 1 wherein one of said first and second gear selectors is disposed on the other of said first and second gear selectors.

13. An apparatus comprising:
a steering column for supporting a steering wheel;
a first gear selector for controlling a selection of a gear arrangement of a transmission from among a first set of a plurality of different gear arrangements and mounted for movement about said steering column and including a lever moveable between a plurality of positions wherein each of said plurality of positions corresponds to at least one of said plurality of different gear arrangements; and
a second gear selector mounted on said lever for controlling a selection of a gear arrangement of a transmission from among a second set of the plurality of different gear arrangements, wherein said first and second sets of gear arrangements are different.

14. The apparatus of claim 13 further comprising:
an electric controller communicating with said first and second gear selectors for controlling a transmission of a vehicle to move between the plurality of different gear arrangements, wherein the plurality of different gear arrangements includes a park arrangement, a neutral arrangement, a reverse arrangement, a drive arrangement, a first low arrangement, and a second low arrangement.

15. The apparatus of claim 14 wherein the lever is movable along a substantially arcuate path between said plurality of positions and wherein each of said plurality of positions corresponds to one of the plurality of different gear arrangements.

16. The apparatus of claim 14 including a third gear selector cooperating with at least one of said first and second gear selectors to control the transmission.
